(19) United States
(12) Patent Application Publication
(10) Pub. No.: US 2007/0103288 A1
(43) Pub. Date: May 10, 2007

(54) DISTRIBUTED COLLABORATIVE SYSTEM FOR PREPARATION, MANAGEMENT AND/OR MAINTENANCE OF AN EMERGENCY RESPONSE PLAN

(75) Inventor: Claire Herard JR., Laval, QC (CA)

Correspondence Address: BERESKIN AND PARR, 40 KING STREET WEST, BOX 401, TORONTO, ON, M5H 3Y2, CA

(73) Assignee: CKURIA VISION INC., Laval, QC (CA)

(21) Appl. No.: 11/552,192

(22) Filed: Oct. 24, 2006

Related U.S. Application Data
(60) Provisional application No. 60/729,745, filed on Oct. 25, 2005.

(51) Int. Cl. G08B 29/00; G06Q 99/00; G08B 23/00

(52) U.S. Cl. 340/506; 340/573.1; 705/1

(57) ABSTRACT

The present invention relates to a distributed collaborative system for preparation and/or maintenance of an emergency response plan. An emergency response plan is a data file containing a plurality of contingencies and respectively, response plans in connection to these contingencies. Different parties, such as property managers, property tenants, emergency respondents and insurance companies, collaborate together electronically via a server to share information and comments on this information. Information on the property is first being provided by some parties (mainly the property manager and tenant) and then, emergency response plans referenced to this information are being prepared and shared on the server by emergency respondents. Following, if necessary, insurance companies, by virtue of their expertise in risk management, open comment threads on this shared information and response plans and, generally, expect responses to their comments or a modification to be carried out by the appropriate party. After closure of comment threads and as a result of this distributive collaboration between parties, emergency response plans are prepared to overcome emergency situations in an efficient and fast way.

### FIELD OF THE INVENTION

The invention relates to preparation, management and maintenance of an emergency response plan.

### BACKGROUND OF THE INVENTION

Traditionally, in the field of preparation and management of emergency response plans, there was lack of efficiency in responding to emergency situations, this was because of lack of coordination in collaboration between the different concerned parties, such as property managers, property tenants, insurance companies and emergency respondents. Lack of standardization in sharing of information between different parties was another reason of this lack of efficiency in responding to emergency situations.

### SUMMARY OF THE INVENTION

There is therefore an object of the present invention to provide a method and a system which overcome the above drawbacks.

According to one aspect of the invention, there is provided a method of collaboration among various parties to build an emergency response plan for a property, the method comprising:
receiving, at a server, structural information provided by manager of said property;
using said structural information by tenant of said property to provide to said server occupant information referenced with respect to said structured information; and
using said structural information and said occupant information by emergency respondents to provide to said server emergency response plan data referenced with respect to at least one of said structural information and said occupant information.

The method of collaboration among various parties to build an emergency response plan for a property preferably further comprises a step of adding on the server comments referenced with respect to at least one of said structural information, said occupant information and said emergency response plan data and sharing these comments among various parties who have access to the server.

The method of collaboration among various parties to build an emergency response plan for a property preferably further comprises a step of receiving an emergency response plan provided by said manager of said property with respect to expertise of said manager of said property and a step of approving or rejecting, by said emergency respondents, said emergency response plan provided by said manager of said property.

The method of collaboration among various parties to build an emergency response plan for a property preferably further comprises a step of receiving an emergency response plan provided by said tenant of said property with respect to expertise of said tenant of said property and a step of approving or rejecting, by said emergency respondents, said emergency response plan provided by said tenant of said property.

An insurance company preferably provides the comments added on the server.

In this specification, by “structural information”, is intended to mean all kinds of technical information about the property, which may include one or more of safety measure specifications, floor plans and internal and external structure plans of said property, such as elevator plans, electronic panel plans and pluming plans.

In this specification, by “occupant information”, is intended to mean all kinds of information in connection with occupants of said property, which may include one or more of number of occupants, location of occupants, nature and location of hazardous materials, nature and location of equipment used by said occupants and times of operations.

In this specification, by “manager of the property”, is intended to mean any actor who manages the property, which could be the same physical or corporate person as the “tenant of the property”.

In this specification, by “tenant of the property”, is intended to mean any actor who uses or occupies the property, which could be the same physical or corporate person as the “manager of the property”.

In this specification, by “emergency respondents”, is intended to mean all actors who are generally called to provide aid in emergency situations, which may include police officers, ambulance personnel, national guard, paramedics and fire fighters.

### BRIEF DESCRIPTION OF THE DRAWINGS

Further features and advantages of the invention will become more readily apparent from the following detailed description of the invention as illustrated by way of examples in the appended drawings wherein:

FIG. 1 is a flow chart showing e-collaboration between different parties to prepare an emergency response plan;

FIG. 2 is a block diagram showing interactive interaction of different users via Internet to modify the emergency plan database;

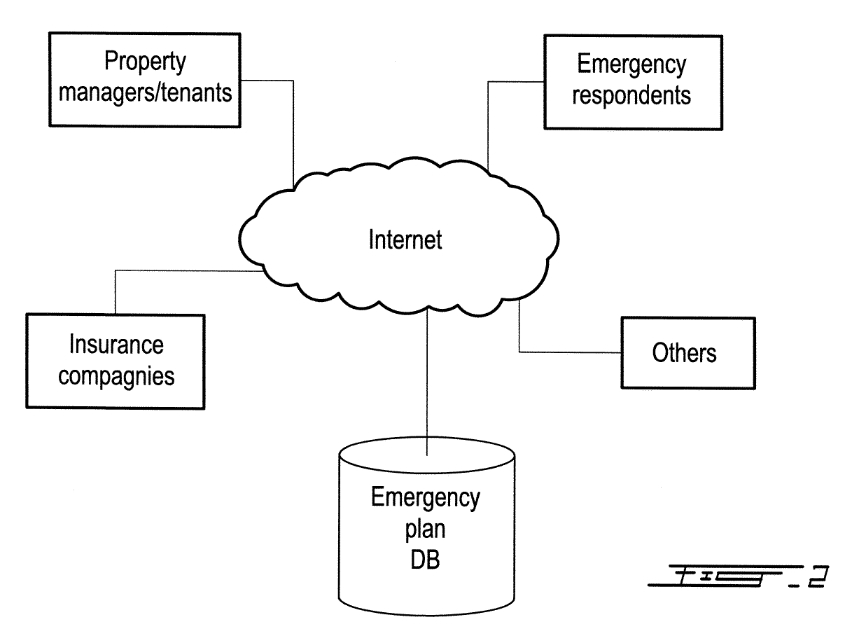

FIG. 3 is a block diagram showing different parties granted read and/or write access for the emergency plan database;

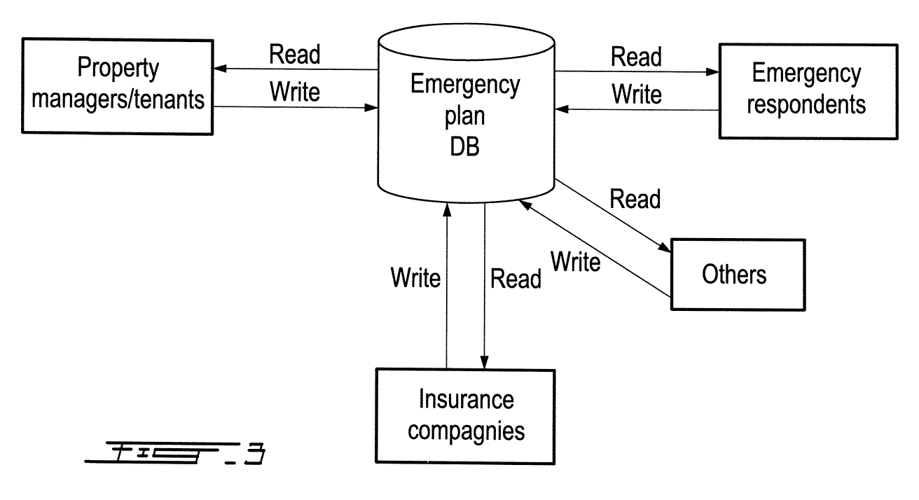

FIG. 4 is a view showing an example of information present in the emergency plan database;

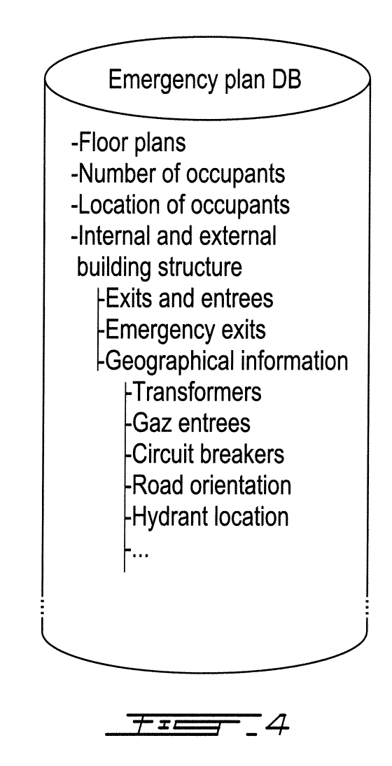

FIG. 5 is a view showing an example of user information stored in the security database;

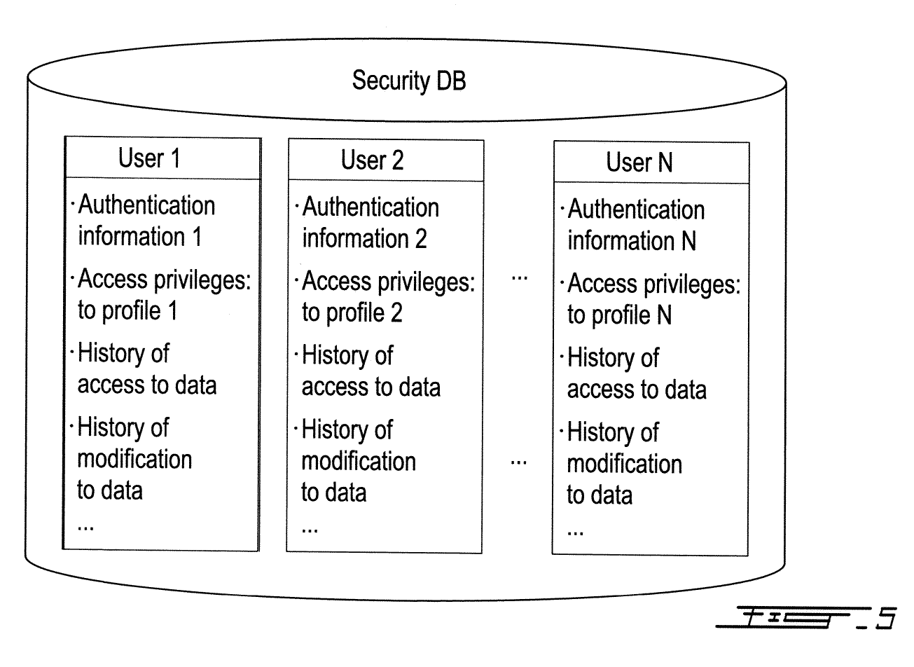

FIG. 6 is a view showing a non-limited list of users who are granted access to the emergency plan database;

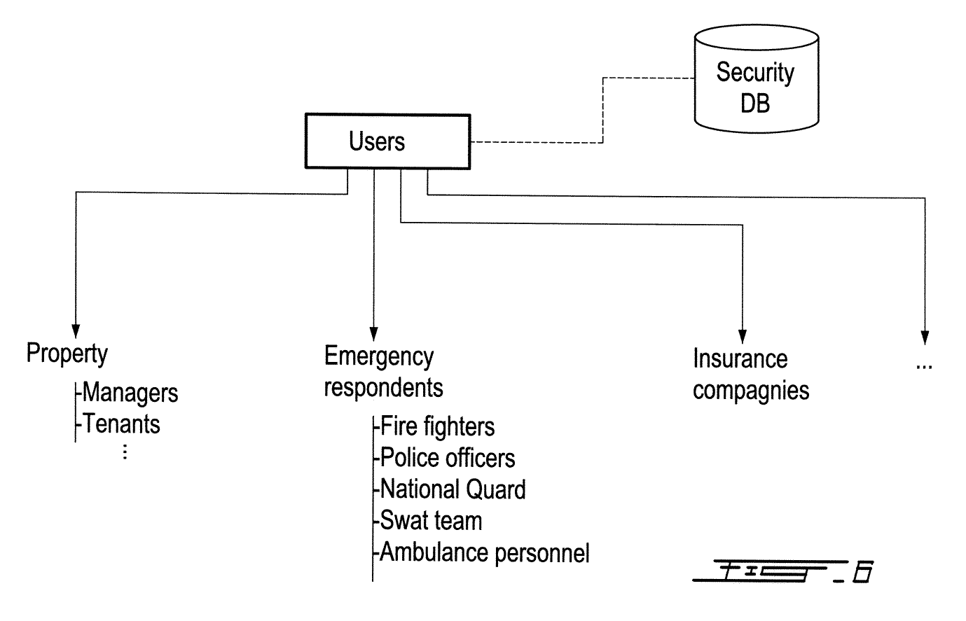

FIG. 7 is a flow chart showing different users granted different view of data;

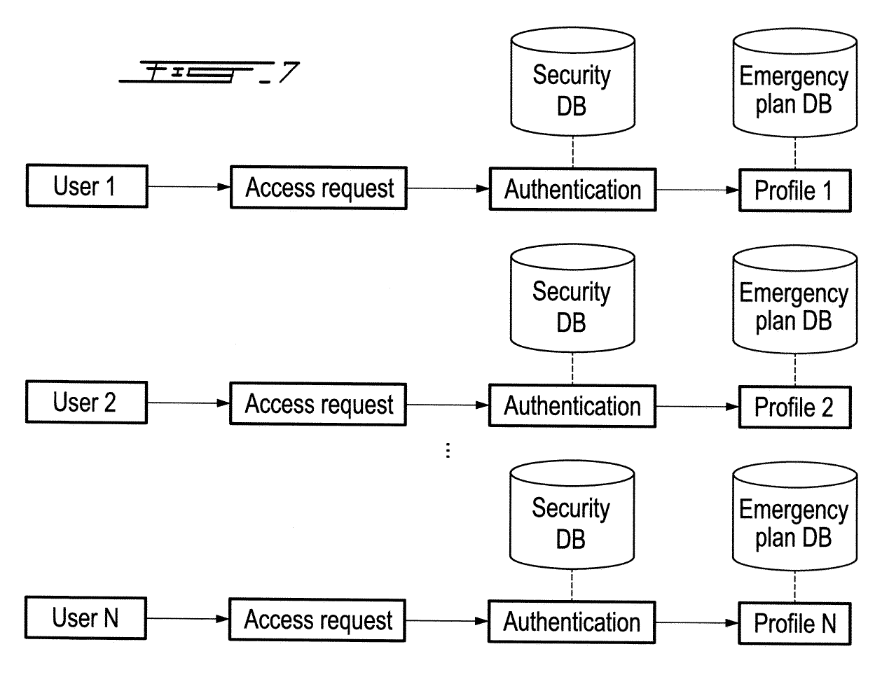

FIG. 8 is a flow chart showing the process of accessing data by a user;

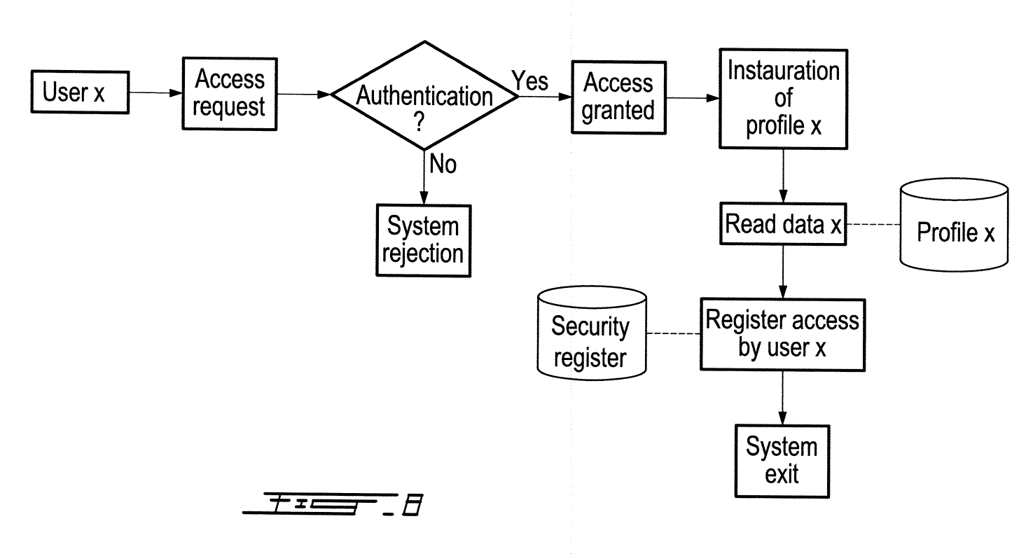

FIG. 9 is a flow chart showing the process of modifying data by a user;

FIG. 10 is a view showing different authentication means used by the system.

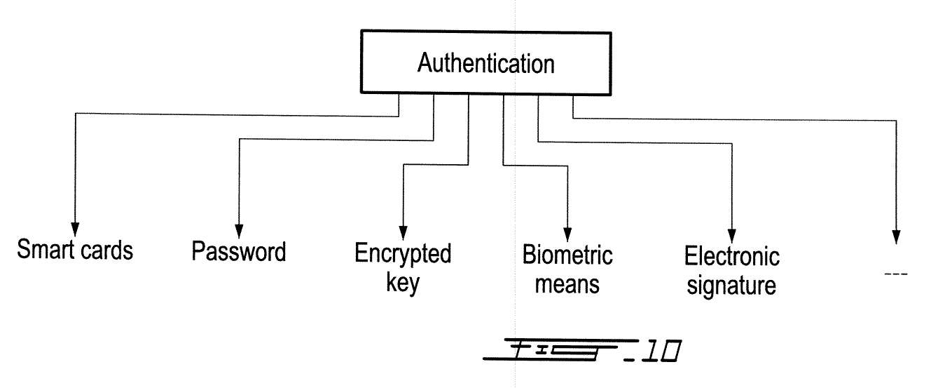

### DETAILED DESCRIPTION OF THE INVENTION

While the invention has been described with particular reference to the illustrated embodiment, it will be understood that numerous modifications thereto will appear to those skilled in the art. Accordingly, the above description and accompanying drawings should be taken as illustrative of the invention and not in a limiting sense.

The present invention relates to a distributed collaborative system for preparation and/or maintenance of an emergency response plan. An emergency response plan is a data file containing at least one of contingency and respective response plans in connection with these contingencies. Various parties, such as property managers, property tenants, emergency respondents and insurance companies, collaborate together electronically via a server to share information and comments on this information.

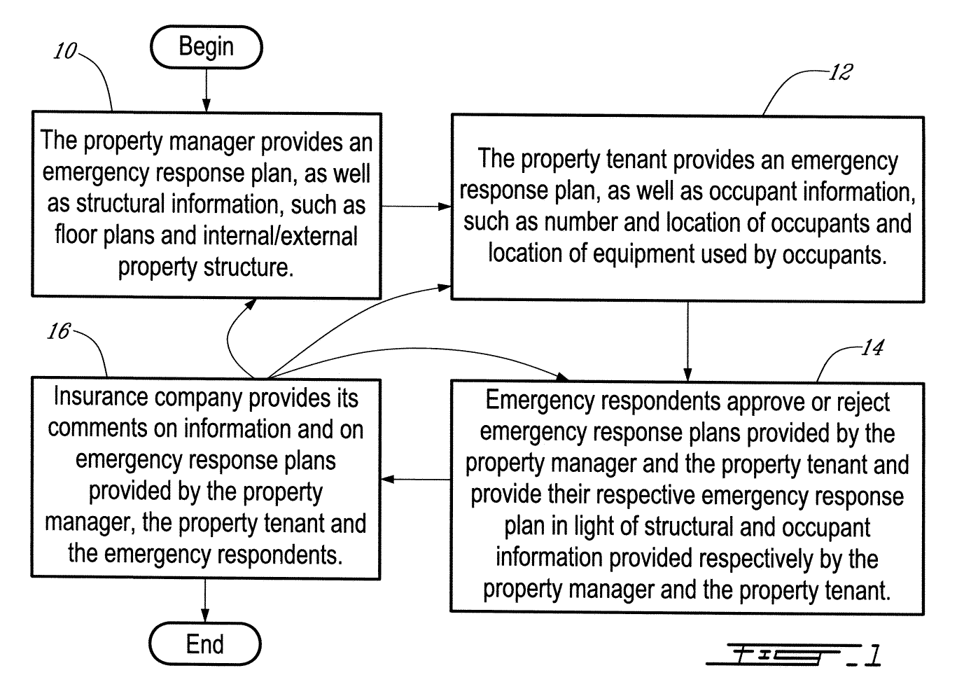

Referring to FIG. 1, there is shown how different parties collaborate together via the network in order to prepare a solid emergency response plan that reflects the expertise of each of the collaborative parties and respects norms and rules. In fact, first, the property manager provides, on the server, an emergency response plan with respect to his expertise, as well as structural information about the property in question, such as safety measure specifications, floor plans and internal and external structure of the property 10. Following this step, the property tenant provides, on the server, an emergency response plan with respect to his expertise, as well as occupant information, such as number and location of occupants and location of dangerous equipment within the property 12. Once emergency response plans and information provided by the property manager and the property tenant become available on the server (i.e. this information is available immediately on the server upon its provision by respective parties), emergency respondents (ex. police officers, ambulance personnel, national guard, paramedics, fire fighters, etc.), in light of norms and rules as well as their expertise, approve or reject the emergency response plans advanced by these parties. Emergency respondents use also information disseminated by the property manager and the property tenant to prepare their own emergency response plan with respect to their expertise, which become immediately accessible on the server upon completion 14. Next, insurance company agents, by virtue of their expertise in risk management, open comment threads on these shared information and emergency response plans 16 and, generally, expect responses to their comments or modifications to be carried out by appropriate parties. After closure of comment threads and as a result of this distributive collaboration between parties, emergency response plans advanced by the various parties are finalized and become available on the server in a trusted version to overcome emergency situations in an efficient and fast way.

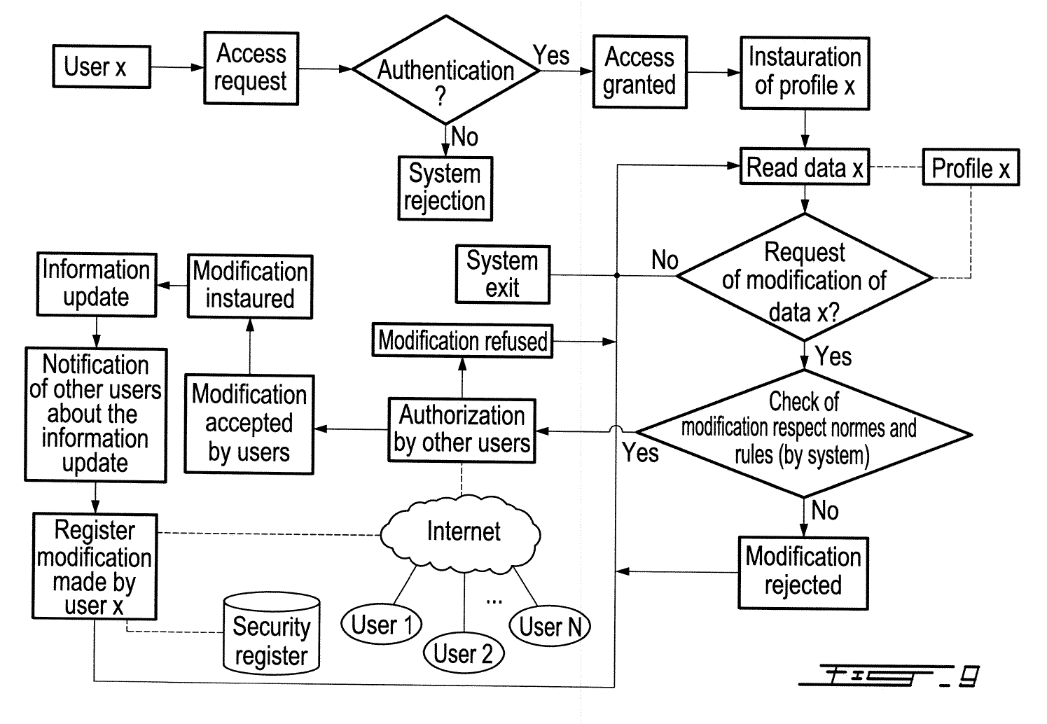

As illustrated in FIG. 9, a rule-based system enables to change dynamically the information representation based on the feed from the different parties, emphasizing the interactivity of the system. For example, property manager submit the changes in the Emergency response plan, which triggers the firefighters with an alert to verify the plan. After the firefighters approve it, the insurance company receives the update, to consider reducing premium costs etc.

An emergency response plan contains a plurality of contingencies and, respectively, emergency response plans in connection to these contingencies. As an example of a contingency, one can imagine a gas leak at a location inside a given building which would put in danger the life of its occupants. As an example of an emergency response plan in connection to this particular contingency (i.e. gas leak at this particular location), one can imagine that fire fighters should enter from back door A at level SB, cross the hallway and pass through entry door C up to floor 3, send a team of 5 fire fighters (team A) to exit all the 50 occupants located on that particular floor down to floor 1 through emergency exit F and send another team of 5 fire fighters (team B) to fix the gas leakage in room 5. Meanwhile, a team of 3 ambulance personnel (team C) should accompany the fire fighters team A in order to provide, if required, aid to occupants in difficulties by effect of gas leakage.

In absence of such an emergency response plan, the technology in question could still be of a big utility. One can imagine the following situation. The fire fighters and the ambulance personnel receive an emergency call informing them of the presence of a gas leak inside the building and of the probable presence of occupants inside the building who would potentially be harmed by the leakage of gas. In order for the fire fighters to rapidly control the situation, on their way to the place of incident, they would access the emergency response plan from the server and determine the location of gas entries inside the building and of the closest entry doors to those gas entrees. Having this information, they would directly move in the direction of these entry doors and check the gas entrees for gas leakage and control the situation. Once they know where does the gas leakage come from, they would directly added to the system so that other parties could have access to the information. In the same time, ambulance personnel would access the server from the ambulance to determine the number and location of occupants next to the gas entree where leakage has occurred. Having this information, they would directly move to those locations in order to free zones in danger and to assist the occupants with any aid if required.

The insurance company preferably has professionals with expertise in risk management, thus it is in the best position to review inputs of the various parties having access to modify the emergency response plans and to, according to risk management principles, provide comments on said modifications and approve or reject such modifications carried out by these parties.

When the insurance company provides a comment thread, this thread is shared between the various parties who have access to the server in order to discuss and cover the gap that is raised by this comment. Following to the creation of a thread by the insurance company, a modification of at least one of said structural information, said occupant information or said emergency response plans in connection of the comment is normally expected to take place. If the modification is satisfactory to the insurance company, the latter will close the thread; otherwise comments will follow until the emergency response plan is satisfactory to the insurance company.

1. A Method of collaboration among various parties to build an emergency response plan for a property, the method comprising:
receiving, at a server, structural information provided by manager of said property;
using said structural information by tenant of said property to provide to said server occupant information referenced with respect to said structured information; and
using said structural information and said occupant information by emergency respondents to provide to said server emergency response plan data referenced with respect to at least one of said structural information and said occupant information.

2. The method as claimed in claim 1, further comprising a step of receiving an emergency response plan provided by said manager of said property with respect to expertise of said manager of said property and a step of approving or rejecting, by said emergency respondents, said emergency response plan provided by said manager of said property.

3. The method as claimed in claim 1, further comprising a step of receiving an emergency response plan provided by said tenant of said property with respect to expertise of said tenant of said property and a step of approving or rejecting, by said emergency respondents, said emergency response plan provided by said tenant of said property.

4. The method as claimed in claim 1, further comprising a step of adding on the server comments referenced with respect to at least one of said structural information, said occupant information and said emergency response plan data and sharing these comments among various parties who have access to the server.

5. The method as claimed in claim 4, wherein said comments added on the server are provided by an insurance company.
